(19) United States
(12) Patent Application Publication
(10) Pub. No.: US 2007/0224373 A1
(43) Pub. Date: Sep. 27, 2007

(54) Integral soft tube with cap and method for making the same

(76) Inventor: Ming-Yuan Wang, Tainan City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/389,719

(22) Filed: Mar. 27, 2006

(51) Int. Cl. B29C 47/20; B31B 45/00

(52) U.S. Cl. 428/34.1; 264/209.1; 264/132; 428/36.9

(57) ABSTRACT

The integral single-piece tube container consists of a soft tube and a dispensing cap. The cap is made of a composite of polypropylene(PP) and polyolefin elastomer (POE). The soft tube is extruded from a composite of polyethylene and POE. The existence of POE in both of the tube and the cap makes the welding of both parts feasible. Since the welding can be done during the molding process of the cap, this invention has some benefits, such as the reduction of processing steps into half, and conservation of material usage up to 30% in comparison with the conventional tube container.

### FIELD OF THE INVENTION

The invention provides the method and materials for manufacturing an integral soft tube and its structures. Technologically speaking, heading is unnecessary for this tube. A cap is welded with the tube body when the cap is being made.

### BACKGROUND OF THE INVENTION

Refer to FIG. 1, which is the flow chart for making a conventional soft tube. The first step involves the extruding tube; the second step involves the heading; the third step involves printing and coating; the fourth step involves opening the orifice by trimming and capping; the fifth step involves the cap manufacturing and the last is assembly of the tube and the cap.

A conventional soft tube 10 with a cap 15 is shown in FIG. 2 and generally includes a connection end 11 connected to an end of the tube 10 and the connection end 11 has a through hole 112 so that the content in the tube 10 can be squeezed out from the through hole 112. The connection end 11 includes a threaded outer periphery 111 so as to be connected with a cap 15 which has a threaded hole 121 which is threadedly connected to the threaded outer periphery 111 of the connection end 11. A lid 13 is connected to the head 12 by a connection piece 14 so that the user can pivot the lid 13 and squeeze the tube 10 to get the content.

This manufacturing method has the following disadvantages:

1. According to conventional manufacturing steps, the tube cap has to be made separately, and then it is connected to tube nozzle 11 by threads 121. It cannot ensure the orientation of the tube cap's finger recess located right against the design position on the tube body. Users cannot open the cap with only one hand while holding the soft tube.

2. There is an unavoidable gap between the tube and the cap assembly. When the tube is used, the content will reside in the gap as a contaminant.

3. Referring to FIG. 1, there are six steps for the conventional manufacturing steps and multiple different machine are required. A longer period of manufacturing time is required.

4. The six steps of the conventional manufacturing steps use a lot of materials and which makes the product with high manufacturing cost.

According to the conventional method, the material is mainly polyethylene (PE) for the soft tube and polypropylene (PP) for the cap. PP cap cannot be joined to the body of the PE tube directly. It needs a heading operation in the forming of a tube nozzle, along with injection molding of a thread cap separately, and then combinational assembly by threads. The conventional method has to adapt to a multiple layer tube to improve the barrier property of PE tube.

As a solution, we offer a method and its structures for making an integral tube. While the cap is molded, it can be welded to the ready-made tube body directly, thus making an integral tube without heading. The cap material is a composite of PP and Polyolefin Elastomer (POE), and the tube body material is PE blended with POE. That causes the tube body to become welded to the cap and effectively inseparable. It is a single layer soft tube, and additives can be added during the manufacturing process with improved barrier properties against substances inside from volatilizing. The barrier will keep out water, air and oxygen, which prolongs the product's shelf life.

With the invention, we not only lower the cost of the production and lessen the material, but also increase the tube volume to fill the content up to the cap.

The present invention intends to provide a soft tube and a cap are integrally connected with the tube so as to reduce the number of manufacturing steps.

### SUMMARY OF THE INVENTION

The present invention relates to a soft tube assembly which comprises a soft tube with a cap integrally connected to an end of the soft tube, and a lid is integrally connected with the cap by a connection piece. A through hole is defined through the cap and in communication with an interior of the soft tube.

The soft tube assembly is made by a step of extruding the tube with an additive added in a material for making the tube; a step of printing/coating/drying, and a step of heading and cap molding.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the steps of the conventional method for making a conventional soft tube assembly;

FIG. 2 is an exploded view to show the conventional soft tube assembly;

FIG. 3 shows the steps of the method for making the soft tube assembly of the present invention;

FIG. 4 is a perspective view to show the soft tube assembly of the present invention;

FIG. 5 shows a wall of the soft tube of the soft tube assembly of the present invention;

FIG. 5-1 is an enlarged cross sectional view of the wall of the soft tube of the present invention;

FIG. 6 is a cross sectional view to show the soft tube assembly of the present invention, and

FIG. 6-1 shows an enlarged view to show the connection between the cap and the tube of the soft tube assembly of the present invention.

### DETAILED DESCRIPTION OF THE PREFERRED EMBODIMENT

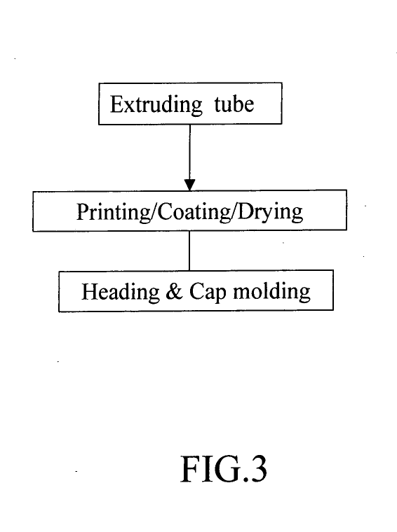

Referring to FIG. 3, the main steps of making an integral soft tube of the present invention are as follows:

1. Extruding tube.

2. Printing/coating/drying.

3. Injection molding cap, with the concurrent welding of the ready-made and ready-printed soft tube body together.

Because the processes of heading the tube nozzle and trimming orifice are irrelevant, and the threaded parts are eliminated, related equipment and materials are not necessary. Moreover, manufacturing processes become simpler. The number of steps is reduced to only a half number of the conventional steps and the material is saved about 30% when compared with the conventional steps.

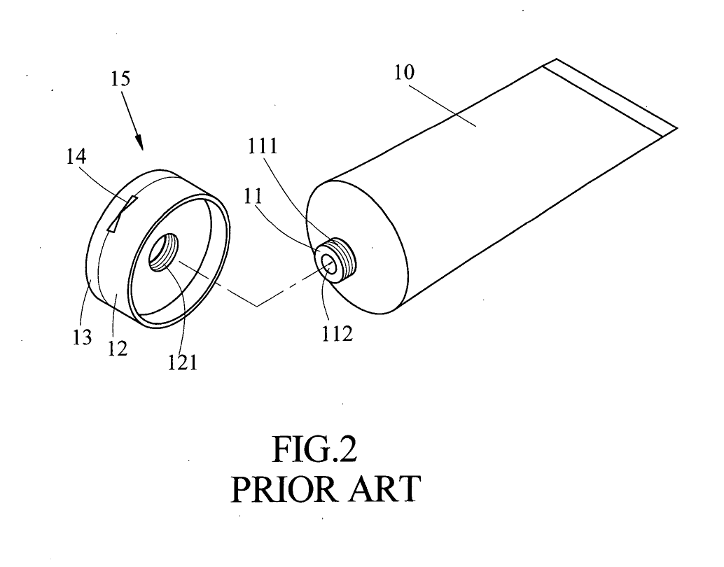

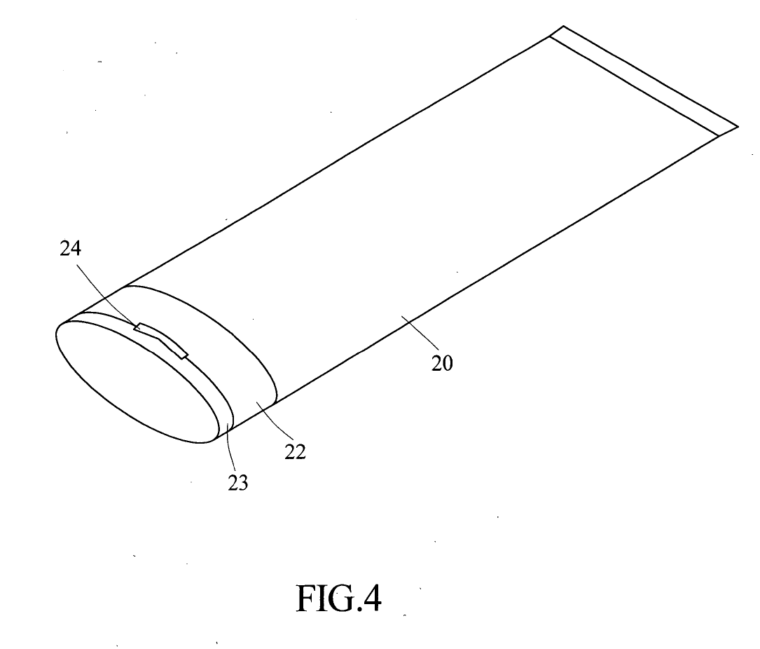

Referring to FIG. 4 and FIG. 2, the conventional soft tube 10 with a cap 15 generally includes a connection end 11 connected to an end of the tube 10 and the connection end 11 has a through hole 112 so that the content in the tube 10 can be squeezed out from the through hole 112. The connection end 11 includes a threaded outer periphery 111 so as to be connected with a cap body 12 which has a threaded hole 121 which is threadedly connected to the threaded outer periphery 111 of the connection end 11. A lid 13 is connected to the cap body 12 by a connection piece 14 so that the user can pivot the lid 13 and squeeze the tube 10 to get the content via the threaded hole 121.

The conventional tube is a tube with a connected cap. The cap has inner threads that coincide to the outer threads of the tube nozzle. The nozzle must have a hole opened in order to allow the contents to flow through the tube body.

Referring to FIG. 4, the present invention tube is a soft tube combined with cap. The soft tube body and the dispensing cap are welded together. Thus, there is no need to mold the tube nozzle, perform trimming, and assemble the cap on the tube.

The soft tube assembly of the present invention comprises a soft tube 20 with a dispensing cap 22 integrally connected to an end of the soft tube 20 by way of welding, and a lid 23 is integrally connected with the cap 22 by a connection piece 24. A tube extends from the cap 22 and a through hole is defined through the head 22 and in communication with an interior of the soft tube 20. An interior of the cap 22 is in communication with the interior of the soft tube 20. Therefore, the space for receiving the contents such as the cream includes the interior of the dispensing cap and the interior of the soft tube will be much larger than the conventional soft tube. The present invention does not need to make the connection end 11, the threaded outer periphery 111, the threaded hole 121, and the through hole 112 in the connection end 11.

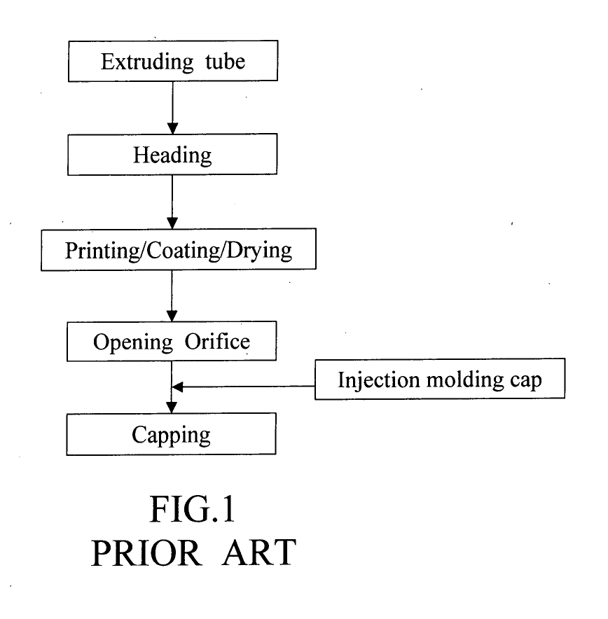

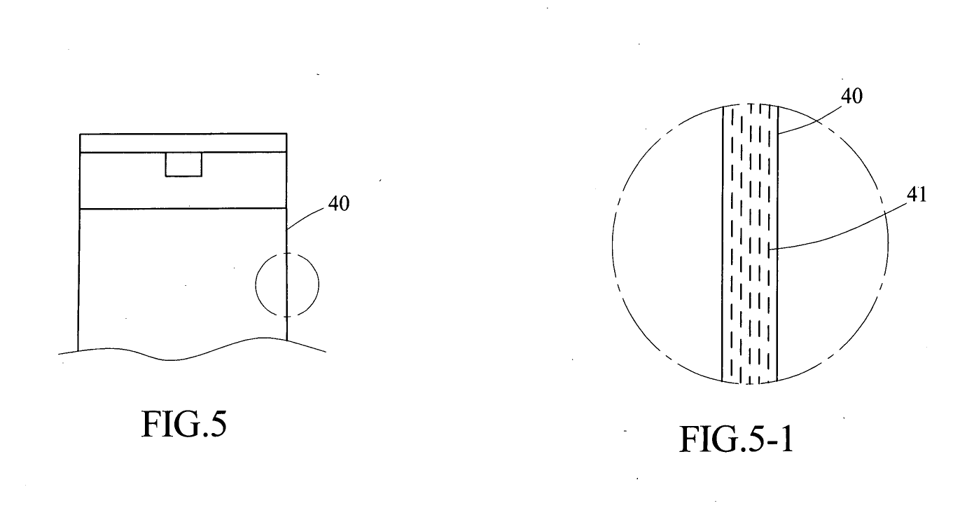

Referring to FIGS. 4 and 5-1, wherein FIG. 5 compares the tube of the present invention with a single layer and the conventional tube with multiple layers. The single layer of the present invention separates air especially for oxygen and water from the contents in the tube. For the conventional tube, in order to prevent the cream from being in contact with air or water from outside of the tube, the wall of the conventional tube includes a barrier layer which is the EVOH and the wall has to be made to be multiple layers.

As shown in FIG. 5-1, the wall of the soft tube is a single layer tube and the material for making the soft tube is Polyethylene with Polyolefin Elastomer added therein so as to become a PE composite. The PE composite can also be added with 3%-5% of Nanoclay (SiO₂, TO₂) to make the single layer tube, so that the wall 40 includes a plurality of barrier plates 41 which prevent air and water to be in contact with the contents in the soft tube 20.

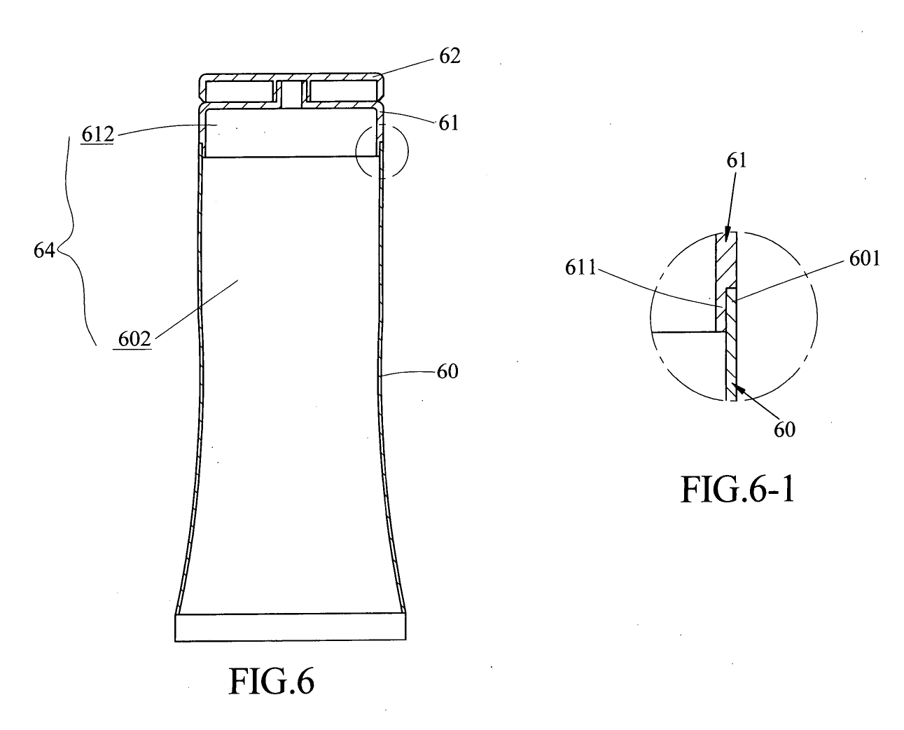

The plastic soft tube of the present invention basically includes a soft tube and a hard cap. Referring to FIG. 6, the soft tube 60 is made of Polyethylene and Polyolefin Elastomer and the additive is Nanoclay (Montmorillonite) (SiO₂, TO₂) or Nano-TiO₂. The cap 61 and the lid 62 are made of Polypropylene and Polyolefin Elastomer. The Polyolefin Elastomer allows the two different materials to be connected with each other by way of hot melting by connecting the end of the soft tube 601 with the annular recess 611 of the cap 61.

Referring to FIGS. 6 and 6-1, the soft tube assembly of the present invention comprises a soft tube 60 with a cap 61 integrally connected to an end of the soft tube 60, and a lid 62 is integrally connected with the cap 61. A tube extends from the cap 61 and a through hole is defined through the cap 61 and in communication with an interior 602 of the soft tube 60. An interior 612 of the cap 61 is in communication with the interior 602 of the soft tube 60. Therefore, the space 64 for receiving the contents such as the cream includes the interior 612 of the cap 61 and the interior 602 of the soft tube 60. The space 64 is much larger than the conventional soft tube assembly.

It is noted that the number of steps is less than the conventional method and the drilling step and the injection molding are not needed so that the material can be saved and the expenses of the machine for drilling and injection molding are saved. There is no gap between the tube 60 and the cap 61 so that the contents in the tube does not be strapped in the gap as of the conventional tube, which avoids contamination for the contents in the tube. The soft tube, the cap and the lid can have a circular cross section, a rectangular cross section, an oval cross section or a polygonal cross section.

While we have shown and described the embodiment in accordance with the present invention, it should be clear to those skilled in the art that further embodiments may be made without departing from the scope of the present invention.

What is claimed is:

1. A soft tube assembly comprising:
a soft tube with a dispensing cap integrally connected to an end of the soft tube. The soft tube being a single layer tube, a cap is molded to the tube integrally.

2. The assembly as claimed in claim 1, wherein the soft tube, the head and the cap has a circular cross section.

3. The assembly as claimed in claim 1, wherein the soft tube, the head and the cap has a rectangular cross section.

4. The assembly as claimed in claim 1, wherein the soft tube, the head and the cap has an oval cross section.

5. The assembly as claimed in claim 1, wherein the soft tube, the head and the cap has a polygonal cross section.

6. A method for making a soft tube assembly, comprising:
a step of extruding the tube with an additive added in a material for making the tube;
a step of printing/coating/drying, and
a step of heading and cap molding.

7. The method as claimed in claim 6, wherein the cap is connected to the soft tube by hot melting.

8. The method as claimed in claim 6, wherein the soft tube is made by Polyethylene and Polyolefin Elastomer.

9. The method as claimed in claim 6, wherein the head and the cap are made by Polypropylene and Polyolefin Elastomer.

10. The method as claimed in claim 10, wherein the additive is Nanoclay (SiO₂, TO₂).
